(19) United States
(12) Patent Application Publication
(10) Pub. No.: US 2003/0056173 A1
(43) Pub. Date: Mar. 20, 2003

(54) Method, system, and program for dynamically generating input for a test automation facility for verifying web site operation

(75) Inventors: Michael Alan Copenhaver, Austin, TX (US); Joel Craig Dunn, Round Rock, TX (US); Jeffrey Walter Richardson, Austin, TX (US)

Correspondence Address: Joseph R. Burwell, Law Office of Joseph R. Burwell, P.O. Box 28022, Austin, TX, 78755-8022, US

(73) Assignee: INTERNATIONAL BUSINESS MACHINES CORPORATION, Armonk, NY (US)

(21) Appl. No.: 10/286,000

(22) Filed: Oct. 31, 2002

Related U.S. Application Data
(63) Continuation-in-part of application No. 09/766,062, filed on Jan. 22, 2001.

(51) Int. Cl. G06F 15/00

(52) U.S. Cl. 715/513

(57) ABSTRACT

A test automation facility for a data processing system is presented which relies on a browser application as a host environment. An initial file is loaded into a browser application window to create separate frames within the window, and the separate frames are used by the test automation facility for a variety of purposes. One of the frames contains a test automation facility interface with test case logic for verifying content, data, documents, or files received from a server. A server-side process, such as a filter servlet, can dynamically insert or modify a triggering element within a document that is sent to the test automation facility. When the browser loads the document containing the triggering element, the triggering element is interpreted to call a function that verifies contents of the document.

### CROSS-REFERENCE TO RELATED APPLICATIONS

The present application is a continuation-in-part application of the following application, which is assigned to the same assignee as the present application and is hereby incorporated by reference:

Application Ser. No. 09/766,062, filed Jan. 22, 2001, titled “Method, system, and program for a platform-independent, browser-based, client-side, test automation facility for verifying Web site operation”.

### BACKGROUND OF THE INVENTION

1. Field of the Invention

The present invention relates to an improved data processing system and, in particular, to a method, system, and program for software development and management. Still more particularly, the present invention provides a method, system, and program for indirectly testing the operation of server-side software in a computing environment by verifying the client-side content.

2. Description of Related Art

The growth of electronic commerce is an integral part of the growth of the Internet. While some well-established enterprises have expanded their legacy operations onto the World Wide Web, many new enterprises rely heavily on their presence on the Web. As time passes, many enterprises continue to improve their online presence with new features that are both more esthetically pleasing and more operationally complex. However, customer relationships may be severely impacted if an enterprise's Web site does not function properly. In order to remain competitive with other enterprises, improvement and maintenance of Web sites have acquired mission-critical importance.

Software products for facilitating and automating the testing of a variety of applications have been commercially available for many years. In order to help enterprises maintain Web sites that are constantly changing, many software products are now commercially available to perform functional testing and load testing of server-side software supporting these Web sites.

However, many of these conventional e-business testing products have inherent problems. For example, some products are platform-dependent, thereby limiting their deployment. Other products incorporate emulation of client-side browsers rather than actually operating client-side browsers during tests, which introduces additional variables to be considered during tests because memory, disk space, and network requirements of the testing application may impact the operational characteristics of the environment that one is testing. Other products require a proprietary scripting language to control the testing software, which burdens the testing personnel by requiring them to learn a proprietary programming language.

Therefore, it would be advantageous to provide a method, system, and program for verifying the operation of Web site server software via a test automation facility that is platform-independent and does not merely emulate the use of a browser. It would be particularly advantageous to provide a method, system, and program that is based on commonly available and readily understood standards such that software developers can quickly learn and use the system without learning proprietary programming languages and interfaces.

### SUMMARY OF THE INVENTION

A method, system, apparatus, and computer program product are presented for a test automation facility. The test automation facility relies on a browser application as a host environment. The browser application has built-in script language interpretation functionality and markup language interpretation functionality for parsing and processing script files and markup language documents with embedded scripts. The browser also provides built-in user interface functionality for interacting with the user to control tests.

An initial file is loaded into a browser application window to create separate frames within the window, and the separate frames are used by the test automation facility for a variety of purposes. One of the frames contains a test automation facility interface with test case logic for verifying content, data, documents, or files received from a server. A server-side process, such as a filter servlet, can dynamically insert or modify a triggering element within a document that is sent to the test automation facility. When the browser loads the document containing the triggering element, the triggering element is interpreted to call a function that verifies contents of the document.

### BRIEF DESCRIPTION OF THE DRAWINGS

The novel features believed to be characteristic of the invention are set forth in the appended claims. The invention itself, further objectives, and advantages thereof, will be best understood by reference to the following detailed description when read in conjunction with the accompanying drawings, wherein:

FIG. 1A depicts a typical network system in which the present invention may be implemented;

FIG. 1B depicts a typical computer architecture that may be used within a data processing system in which the present invention may be implemented;

FIG. 1C is a block diagram depicting the functional components that may be found within a typical browser that operates in a client-server environment;

FIG. 2A is a block diagram that depicts the content area within a window of a client-side browser application in which the content area has been divided into separate frames for supporting the test automation facility;

FIG. 2B depicts a browser application window that contains an example of a test automation facility in accordance with a preferred embodiment of the present invention;

FIG. 3A depicts a portion of a document for the left-side frame of the test automation facility;

FIGS. 3B-3D depicts portions of JavaScript files for the test automation facility;

FIG. 4A depicts a portion of an HTML document received at the client-side browser for a requested URI;

FIG. 4B depicts a portion of the JavaScript file containing the identified test case function;

FIGS. 5A-5B depict a flowchart that shows an overview of the steps that occur during the execution of a test procedure within the test automation facility;

FIG. 6 is a block diagram that depicts a server that supports a filter servlet that dynamically inserts a triggering element into a document that is returned to a test automation facility at a client; and

FIG. 7 is a flowchart that depicts a process within a test automation facility servlet that filters output documents to insert appropriate triggering elements into the output documents, wherein the triggering elements are used by a test automation facility at the client to test the documents after they are received at the client.

### DETAILED DESCRIPTION OF THE INVENTION

The present invention provides a method, system, and program for an automated test facility that relies upon a browser application deployed within a networked environment. Therefore, as background, a typical organization of hardware and software components within a network system is described prior to describing the present invention in more detail.

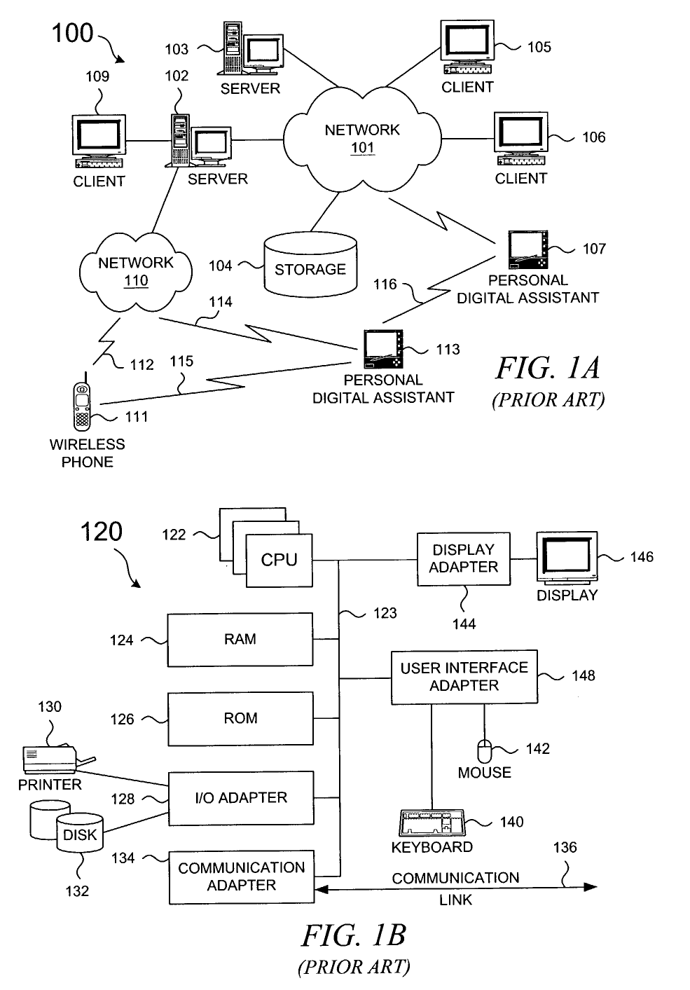

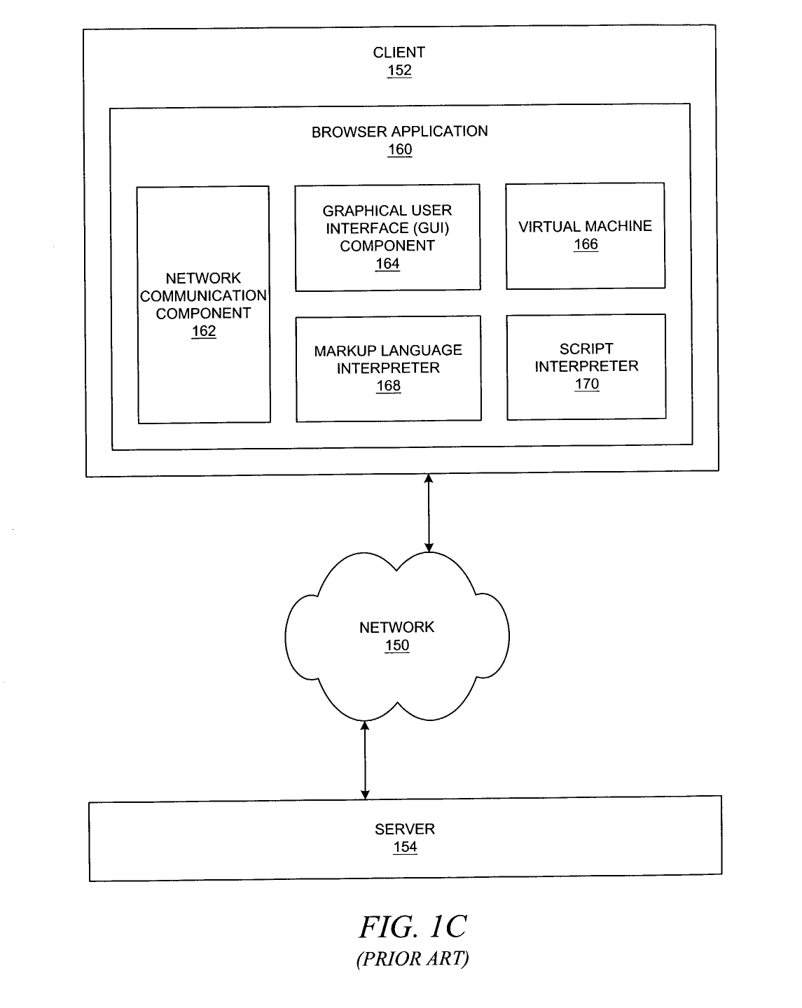

With reference now to the figures, FIG. 1A depicts a typical network of data processing systems, each of which may implement the present invention. Network system 100 contains network 101, which is a medium that may be used to provide communications links between various devices and computers connected together within network system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Network system 100 may include additional servers, clients, routers, and other devices that are not shown.

In the depicted example, network system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, network system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. In other words, one of ordinary skill in the art would not expect to find similar components or architectures within a Web-enabled or network-enabled phone and a fully featured desktop workstation. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing documents, files, and applications in a variety of formats, such as applets, graphic files, word processing files, Extensible Markup Language (XML), Hypertext Markup Language (HTML), Handheld Device Markup Language (HDML), Wireless Markup Language (WML), and various other formats and types of files.

The present invention may be implemented on a variety of hardware and software platforms, as described above. More specifically, though, the present invention is directed to providing a method, system, and program for an automated testing facility for indirectly verifying the operation of server-side software by receiving the output from the server at a client-side browser and performing certain testing functionality while relying on the built-in capabilities of a typical browser, as described in more detail below. As background, the functionality of a typical browser in a client-server environment is described prior to describing the present invention in more detail.

With reference now to FIG. 1C, a block diagram depicts the functional components that may be found within a typical browser that operates in a client-server environment. Network 150 permits communication between client 152 and server 154, which executes a variety of software applications that support one or more Web sites and provide information and services. Client 152 supports a variety of applications, including browser application 160 that enables a user to perform certain actions with respect to server 154, such as viewing documents from server 154.

Browser 160 comprises network communication component 162 for sending and receiving requests and responses to server 154, e.g., HTTP data packets. Graphical user interface (GUI) component 164 displays application controls for the browser application and presents data within one or more content areas, e.g., frames, of the one or more windows of the browser application. Browser application 160 may contain a virtual machine, such as a Java® virtual machine (JVM), which interprets specially formed bytecodes for executing applications or applets within a secure environment under the control of the virtual machine.

Browser application 160 contains markup language interpreter 168 for parsing and retrieving information within markup-language-formatted files. Typically, when a user of client 152 is viewing information from a Web site, browser application 160 receives documents that are structured in accordance with a standard markup language; a markup language document contains tags that inform the browser application of the type of content within the document, what actions should be taken with respect to other documents referenced by the current document, how the entities within the document should be displayed or otherwise presented to a user, etc. For example, most Web pages are formatted with HTML tags.

Browser application 160 also contains script interpreter 170 for parsing and interpreting one or more script languages that may be supported by the browser application. According to the Microsoft® Press Computer Dictionary, Third Edition, a scripting language is “a simple programming language designed to perform special or limited tasks, sometimes associated with a particular application or function.” For example, most browsers contain support for the JavaScript® language, which is a cross-platform, object-based scripting language that was originally developed for use by the Netscape® Navigator browser. Scripting languages cannot be used to write stand-alone applications as they lack certain capabilities. Moreover, scripting languages can run only in the presence of an interpreter.

When a user makes a request to view a Web page within a browser, e.g., by clicking on a hyperlink within another Web page, the user's client eventually sends a request for the Web page to a server by identifying the Uniform Resource Locator (URL) of the Web page, which returns a document comprising the Web page as a response to the client. More general content that is identifiable by Uniform Resource Identifiers (URIs), a superset of standard identifiers that includes URLs, may also be requested. Returned documents usually contain content that has been formatted with HTML tags, and some of the content may comprise embedded JavaScript® statements. The client-side browser processes the HTML document and interprets the JavaScript® statements, which may initiate operations upon entities within the HTML document and/or objects within the browser environment. The resultant data is then presented to the user in some fashion on the client machine.

Microsoft® JScript® is a scripting language similar to JavaScript® for use within Microsoft® Internet Explorer. To establish a standard scripting language, the European Computer Manufacturing Association (ECMA) has promulgated the ECMAScript Language Specification, also known as ECMA-262, which is similar to both JavaScript® and JScript™. While there may be incompatibilities between the scripting languages, it may be assumed that future versions of JavaScript® and JScript® will be compatible with the ECMAScript specification.

The characteristics of a scripting language are herein reiterated according to the ECMA-262 specification:

A scripting language is a programming language that is used to manipulate, customize, and automate the facilities of an existing system. In such systems, useful functionality is already available through a user interface, and the scripting language is a mechanism for exposing that functionality to program control. In this way, the existing system is said to provide host environment of objects and facilities which completes the capabilities of the scripting language. . . . A web browser provides an ECMAScript host environment for client-side computation including, for instance, objects that represent windows, menu, pop-ups, dialog boxes, test areas, anchors, frames, history, cookies, and input/output. Further, the host environment provides a means to attach scripting code to events such as change of focus, page and image loading, unloading, error, abort, selection, form submission, and mouse actions. Scripting code appears within the HTML and the displayed page is a combination of user interface elements and fixed and computed text and images. The scripting code is reactive to user interaction and there is no need for a main program.

Using the built-in capabilities of a typical browser, including its script interpreter functionality, the present invention creates a client-side test automation facility that can perform various tasks, such as exercising server software, by submitting requests to the server software and then visually and programmatically verifying the contents returned to the client. The facility is able to submit forms to the server to exercise Java® servlets, Java® server pages (JSPs), etc. The test automation facility is platform-independent because it can run portable test cases on any operating system that has a supported browser.

The present invention creates a test automation facility by using the recognition that the built-in functionality of the browser can be used as a host environment to initiate tests that verify the returned content and then display the results. In order to accomplish these goals, the facility uses a combination of one or more markup language elements (demarcated by markup tags) and scripting language statements to conduct browser-based tests of Web sites. While the content returned to the client-side browser needs to be configured to include one or more particular elements, all of the test verification logic resides within a single browser process on the client.

For a given testing procedure, each URI to be evaluated must include a triggering element that triggers the execution of test procedure logic within the browser. For example, a testing procedure may attempt to verify dynamic server-generated content within a Web page that comprises both dynamic and static content, and the triggering element must be placed within the content to be evaluated. The triggering element may be dynamically generated by the server while generating the response, or the element may already have been placed within the static portion of the returned content. The returned content may also include scripting language statements.

Test procedure logic in the form of scripting language statements have been previously loaded (or are retrievable) into the client-side browser in some fashion prior to the triggering event. When triggered, the test procedure logic operates on the returned content and then displays the computed results.

In the preferred embodiment, the test procedure logic comprises multiple test cases, each of which performs different verification procedures on the returned content. Hence, the returned content preferably includes an element that allows the identification and selection of one of the test cases.

The manner in which the present invention implements a test automation facility is described in more detail below. While the following examples depict the use of HTML and JavaScript®, the present invention could be implemented using other markup languages and/or scripting languages, assuming that they are interpretable by a browser that provides a sufficient host environment for the test automation facility.

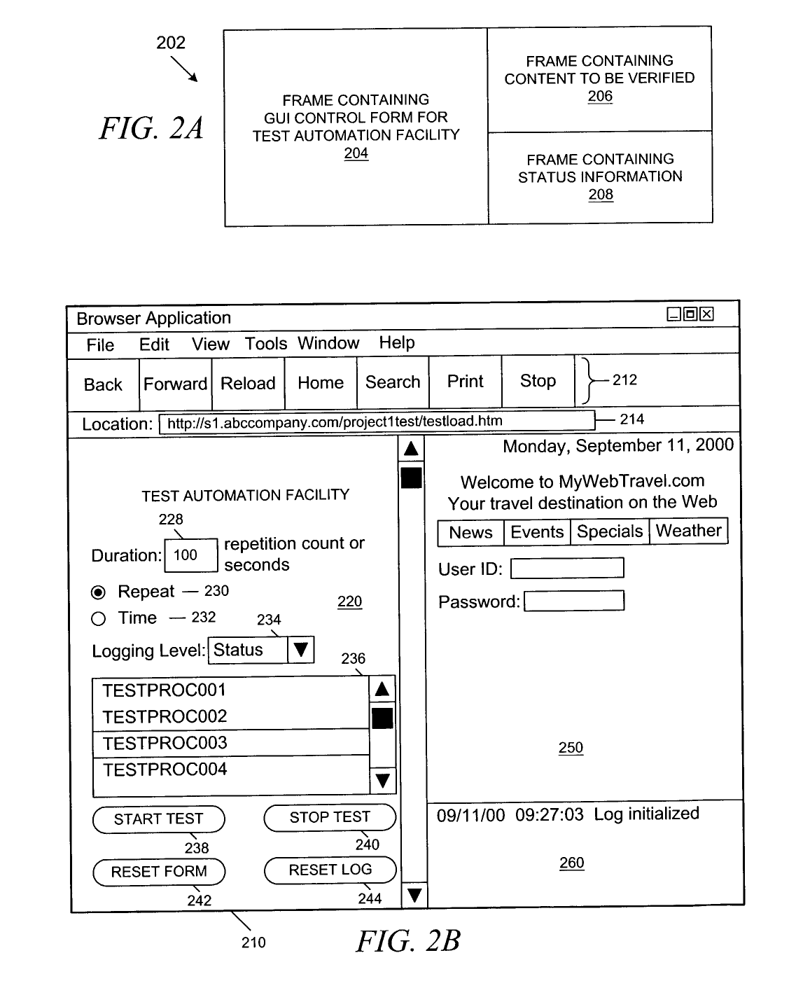

With reference now to FIG. 2A, a block diagram depicts the content area within a window of a client-side browser application in which the content area has been divided into separate frames for supporting the test automation facility. FIG. 2A shows content area 202 of a browser application window that has been divided into frames 204-208. FIG. 2A merely depicts a generic frame set, while FIG. 2B depicts an example of an implemented test automation facility. Assuming that the browser can properly interpret a markup language that supports frames, specific markup tags within a document can divide the content area of the browser application window into separate frames. The browser can then load different documents into each frame.

As previously noted, a typical browser application is used as a host environment for the test automation facility; the present invention relies upon the markup language interpretation functionality and scripting language interpretation components of the browser, as shown in FIG. 1C. While each of these frames may use the markup language and scripting language interpreting functionality of the browser, in the preferred embodiment, each frame has a dedicated purpose.

Frame 204 presents GUI controls that allow a user to control the testing procedure and to select parameters to be used during the testing procedure. Frame 206 presents the content received from the server, i.e., the data against which test procedures are to be executed. Frame 208 is a log window for displaying various operational messages from the test automation facility.

Frame 204 presents a markup language document that contains HTML statements and scripting language statements that comprise a programmatic structure for invoking the test case logic to be executed against content received from the server. The test case logic may be stored within this markup language document or, preferably, stored within separate documents/files that are referenced by this markup language document.

Assuming that the test procedure is verifying the content of a Web page, which presumably contains some portion of its content dynamically generated by the server, frame 206 is used to contain the Web page associated with a particular URI. For example, at some point in time, a user initiates a test using a control within frame 204, and the test case contains logic to load a particular URI into frame 206. In response, the browser sends a request containing the URI to the server, and the browser then loads the received document/data into frame 206. As mentioned previously, the received content must contain some type of triggering element that causes the test case logic to be executed against the received content. In other words, a small amount of server-side participation is required to ensure that the received content contains a triggering element. In the preferred embodiment, assuming that the received document is an HTML-formatted document, the triggering element is an “onLoad” function call within its “BODY” element; the referenced function name must match a function name within the test case logic.

Frame 208 contains the log portion of the test automation facility. As the referenced test case function is executed, log messages containing various information may be presented to the user that is running a test. Information could be written into frame 208 that depicts whether or not the received document in frame 206 contains the appropriate content as expected by the test case logic.

With reference now to FIG. 2B, a browser application window contains an example of a test automation facility in accordance with a preferred embodiment of the present invention. Window 210 is displayed by a browser application that acts as a host environment for the test automation facility. Buttons 212 are typical browser navigation controls. Entry field 214 allows a user to enter a URL or URI that contains an HTML document that provides a programmatic structure for the test automation facility. In this example, a user has entered a file name “testload.htm”, and the processing of this file by the browser has caused other documents to be loaded into the set of frames in the content area of the browser application window. In an HTML document, the “FRAMESET” and “FRAME NAME= . . . ” tags can be used to set up a set of frames.

Browser application window 210 displays a set of frames similar to those described above with respect to FIG. 2A. Frame 220 contains a form that is used to control one or more tests. Data entry field 228 allows a user to enter a duration parameter value that represents the count of loop iterations through the test procedure or the number of time units, e.g., seconds or even hours and minutes, as chosen by the user with radio buttons 230-232.

Drop-down menu 234 allows a user to choose different levels, i.e. amounts, of message logging during a test procedure, such as “debug”, “info”, “status”, “warning”, and “error”. For example, a debug level would allow copious debug messages to be written to the logging frame, whereas an error level would only write catastrophic messages. These messages are generated by the test case logic, and messages from each level could be shown in different colors.

List menu 236 provides a choice of test cases from which the user may choose. Multiple list items may be chosen, which would then execute as a set in sequential order.

Button 238 allows the user to start the test procedure, while button 240 stops the test procedure. Button 242 allows the user to reset the parameter values in the form, and button 244 allows the user to clear the log shown in the status window. Other options could be provided in the form, such as specifying a file to which the log should be saved, etc.

Frame 250 contains the contents of the document that was received during the test case that was chosen and executed by the user. As explained in more detail further below, a “semaphore” document is loaded into this frame after the test case logic is completed; the semaphore document releases control from the user-written test case logic back to the test automation facility logic.

A blank document can be loaded into frame 250 after the completion of the test case logic to reset the contents of the frame. The blank document does not trigger a test case function, i.e., it does not have an “onLoad” function call in its “BODY” element/tag. Preferably, the blank document is a simple document that sets a solid background color. If the user has requested that the test procedure repeat or loop, then the user may be able to see frame 250 being reset and refilled as visual evidence that the test procedure is continuing. In fact, the blank document may also be loaded into frames 250 and 260 by the initial test automation facility document, e.g., “testload.htm” in the example in FIG. 2B, in order to clear these window regions. Frame 260 contains the log messages that were generated during the test procedure.

Since the test automation facility of the present invention relies upon the browser application as a host execution environment, the test automation facility can beneficially employ the GUI features of the browser during the execution of the test automation facility. If the test procedure does not encounter any browser, network, or operating system problems, then the test procedure will automatically end whenever the specified amount of time has elapsed or the number of loops has been completed. However, the user can manually stop the test before its scheduled completion in three ways. First, the user can click the browser's “Stop” button in toolbar 212. The browser will stop loading the document into frame 250, and the browser may overwrite the contents of frame 250 with an error message. Second, the user may right-click in frame 250 to access a pop-up menu and then use a “Stop” menu item if it is available in the pop-up menu. Third, the user can click the “Stop Test” pushbutton 240 in frame 220 which will load the blank document into frame 250.

Any pop-up windows or dialog boxes displayed during the test procedure by the browser application or operating system, such as those caused by browser, network, or operating system events outside of the scope of the test, will pause the test case. The browser model is event-driven, so the test procedure waits until a document has been loaded into frame 250, which subsequently triggers the calling of the test case function.

If the test case has been paused or stopped, the user can restart it by attempting to reload the document into frame 250. In many browsers, when the user right-clicks in a frame, a pop-up menu displays a set of options to the user, and the menu usually includes an option such as “Reload Frame” or “Back”. By selecting one of these options, the browser application attempts to reload the document, or equivalently, to load the document that was previously loaded into the frame. These actions do not reset the timer or loop counter variables in frame 220. If the user desires to restart the test procedure and reset the duration parameters, then the user may select Start button 238 in frame 220.

In the preferred embodiment, the test automation facility comprises four HTML files and two JavaScript files. As described with respect to FIGS. 2A-2B, a user may load an initial document, e.g., “testload.htm” in FIG. 2B, to initialize the test automation facility within the browser execution environment. The initial document creates a set of frames into which other documents are loaded. The initial document can also call functions to check the browser execution environment, such as checking whether the browser supports frames. As noted above, a blank document is also available; for reference purposes, this document can be titled “blank.htm”.

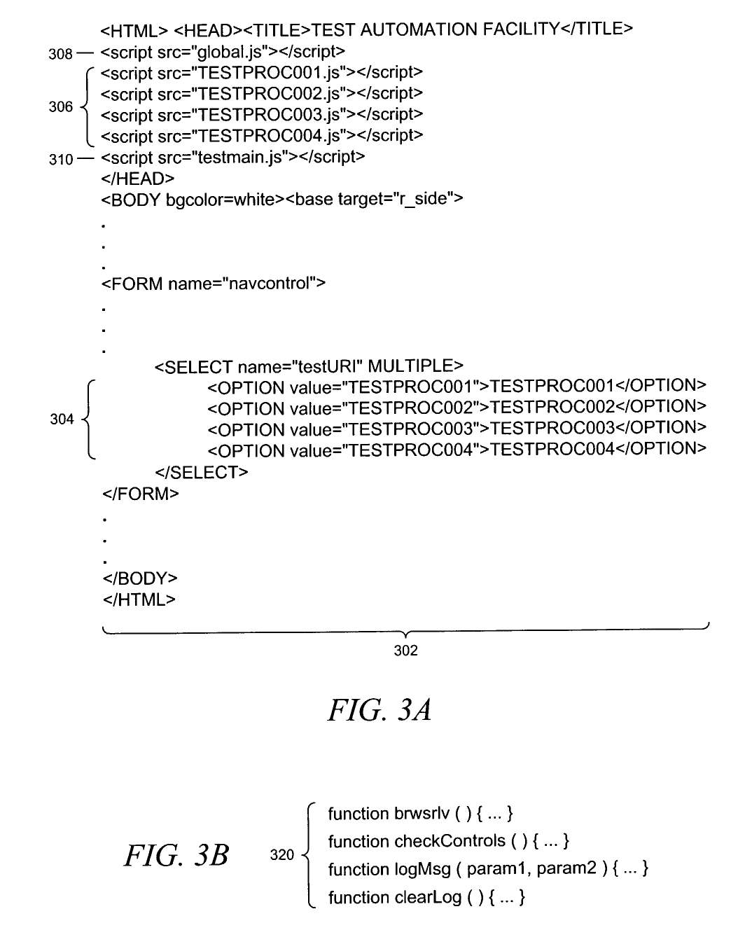

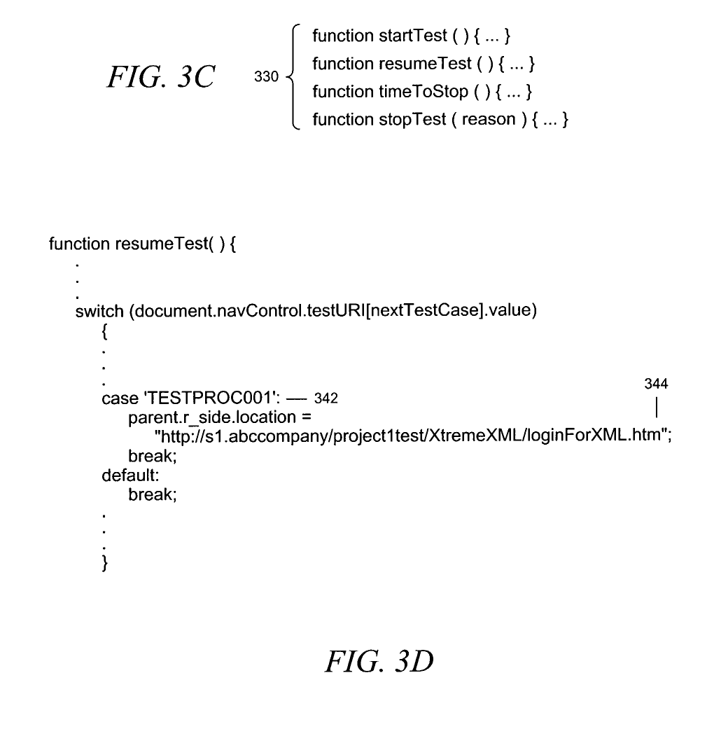

FIGS. 3A-3D provides examples of portions of other documents that are used during the execution of the test automation facility. These examples depict the flow of control during the processing of the markup language elements or scripting language statements in the various documents.

With reference now to FIG. 3A, a portion of a document for the left side frame of the test automation facility is depicted. FIG. 3A depicts a portion of a document for the left-side frame, i.e., frame 220 in FIG. 2B, which contains the GUI elements for controlling the execution of the tests. For reference purposes, this file is titled “load_ctl.htm”, which is the third of the four HTML files mentioned above as comprising the test automation facility. The fourth file, described further below, is the semaphore document mentioned above with respect to FIG. 2B.

During the processing of the initial file “testload.htm” by the browser, the browser creates the set of frames requested within file “testload.htm” and loads the documents for these frames. File “blank.htm” may be loaded into both the message logging frame and the right-side content frame. File “load_ctl.htm” is loaded into the left-side frame, and the browser awaits further user actions, which should eventually include selection of the “Start Test” button.

Referring to FIG. 3A, lines 302 show some of the statements within file “load_ctl.htm” for a form with test case options. Elements 304 show the test cases that are available to be chosen by the user. Elements 306 reference the test case logic files containing the scripting language (JavaScript) statements that correspond to the test case options. The user would modify these elements to add or delete test cases as necessary for the user's requirements in completing testing procedures with the test automation facility.

As noted above, the test automation facility comprises two JavaScript files. Element 308 references the JavaScript file containing global facility variables and error checking or other general purpose functions. Element 310 references the JavaScript file containing functions relating to the starting, stopping, resuming of the test case logic.

With reference now to FIGS. 3B-3D, portions of JavaScript files for the test automation facility are depicted. FIG. 3B shows functions 320 within file “global.js” that was referenced by element 308 in FIG. 3A. The “brwsrlvl” function verifies whether a supported browser is being used to execute the test automation facility. For example, a user may write test case logic that depends on a relatively new feature of a browser or a scripting language that is not supported by older versions of certain browsers. Rather than debug any errors caused by unsupported features, a check can be made as to whether the browser is a type or version that does not support one or more critical features. The “checkControl” function checks or sets variables based on the form options chosen by the user through controls from the file “load_ctl.htm”. The “logMsg” function outputs time-stamped messages to the message logging frame; the function accepts a parameter for the input string and a parameter for the logging level. The “clearLog” function clears the message logging frame by loading a blank file such as “blank.htm”.

FIG. 3C shows functions 330 within file “testmain.js” that was referenced by element 310 in FIG. 3A. The “startTest” function contains the “main program” type of logic for controlling the execution of the test procedures. The “resumeTest” function determines which test case executes next within a test loop. The “timeToStop” function checks for end-of-test conditions as specified by the duration parameter chosen by the user. The “stopTest” function provides for a manual or programmatic end to the test and accepts a string or reason code to be logged.

FIG. 3D shows further detail of the “resumeTest” function from the file “testmain.js”. Statement 342 uses one of the GUI option values in statements 304 in FIG. 3A to select the URI to be loaded into frame 250 shown in FIG. 2B. The user would add or delete case statements as necessary with the URIs identifying the content that the user wishes to test or verify with the test automation facility.

As should be apparent with respect to FIGS. 3A-3D, the addition or deletion of a test case requires similar changes to multiple files to ensure that the appropriate test case logic is processed at the appropriate time in conjunction with a given document. These changes could be automated through a utility that updates the files in the appropriate manner such that the user is not required to edit multiple files.

With FIGS. 3A-3D providing some background, the initial states in the flow of control can be described. After the initial file “testload.htm” has been loaded and the user has selected to start a test, the “startTest” function is eventually called, which can perform some optional environment checking, e.g., by calling the “brwsrlvl” function or the “checkControls” function. Prior to completing, however, the “startTest” either calls the “resumeTest” function or loads the semaphore document. The semaphore document, which for simplicity purposes can be titled “resumeTest.htm”, can be a relatively simple HTML document that has an “onLoad” function call in its “BODY” element/tag to the “resumeTest” function.

After the document has been loaded, the “resumeTest” function is called, and the control flow then begins the test procedure and continues in an execution loop, if necessary, to repeat the test procedure. Hence, control remains within the “resumeTest” function until the user stops the test or until the test procedure stops automatically. The “resumeTest” function may call the “timeToStop” function to determine whether or not another loop iteration should be completed, and if so, then the process repeats. As shown in FIG. 3D, the “resumeTest” function eventually loads a document from a particular URI associated with at least one user-selected test procedure.

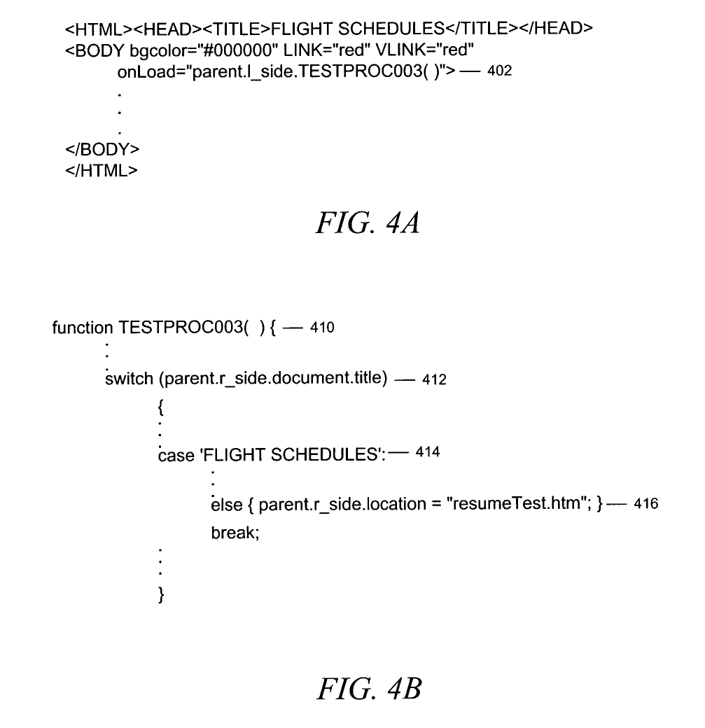

With reference now to FIG. 4A, a portion of an HTML document received at the client-side browser for a requested URI is shown. Line 402 contains a “BODY” tag with an “onLoad” function call to the test case function that is to be applied against the incoming document. An “onLoad” event occurs when the browser has finished loading a window. Hence, after the incoming document has been loaded, the “onLoad” event handler causes control to be transferred to the identified test case logic.

With reference now to FIG. 4B, a portion of the JavaScript file containing the identified test case function is shown. Following the previous examples, the “TESTPROC003” function is located within file “TESTPROC003.js”. Statement 410 identifies the “TESTPROC003” function, which is the target of the “onLoad” function call of the received document. The test case function can be applied to more than one type of document; statement 412 shows that the value of the title element in the received document can be used to apply specific processing steps to the type of document against which the test case function is being applied. Statement 414 shows a case selection for a title equal to “FLIGHT SCHEDULES”, which is the title of the document shown in FIG. 4A.

Other statements that are particular to the test procedure for verifying portions of the document can be placed within this section of the test case function. The server may have dynamically generated a portion of the received document while servicing the request from the client, and the test case logic can verify one or more portions of the document. If errors are encountered, messages can be logged and the test may be stopped.

At the end of the processing of the document, depending on the complexity of a test procedure, another document to be processed or verified could be loaded. After all of the test case logic has completed its processing, the test case function then loads the semaphore document, i.e., it loads file “resumeTest.htm”. The semaphore document identifies that the “resumeTest” function should be called upon completion of loading “resumeTest.htm”, and control is then transferred to the “resumeTest” function. As previously explained above, the “resumeTest” function determines whether or not another loop through the test case logic should be performed.

In the examples above, the names of the functions and files have been simplified for explanatory purposes. The files may be stored within directories and longer pathnames may be used. In addition, the function names, file names, and GUI option names do not necessarily have to be the same. In the example, the same identifier “TESTPROC003” was used as: the value in the GUI option that is presented to the user prior to the test; the value in the “resumeTest” function that corresponds to the GUI control; the name of the file for the JavaScript statements associated with the test case function; the value of the function identifier for the “onLoad” function in the “BODY” tag; and the name of the test case function itself.

The value of the title element of the received document has been used as an entry point into the test case logic. Alternatively, a string could have been passed in through the “onLoad” function.

Scripting languages can access many objects or elements within a document, but these languages are somewhat simplified and cannot necessarily parse all of the content within a document. As an alternative, the servlet or CGI (Common Gateway Interface) script on the server can execute code that sets JavaScript variables with particular values as part of the dynamically generated output. For example, a “SCRIPT” element could be embedded within document, and the “SCRIPT” element could include statements that set values of variables, obviously taking care that the names of the variables do not collide with variable names that are used within the test case logic. The client-side test case logic can then access those variables. The embedded “SCRIPT” element does not affect the presentation of the received document, but the variables could be strings with values equal to portions of the generated content, thereby providing an easy manner of accessing the values of the dynamically generated content without the necessity of parsing the received document.

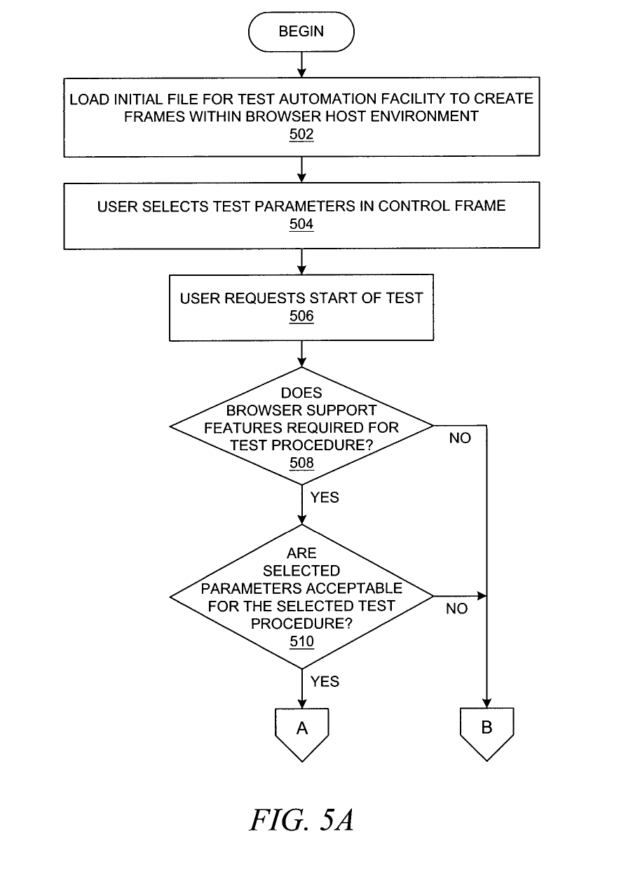

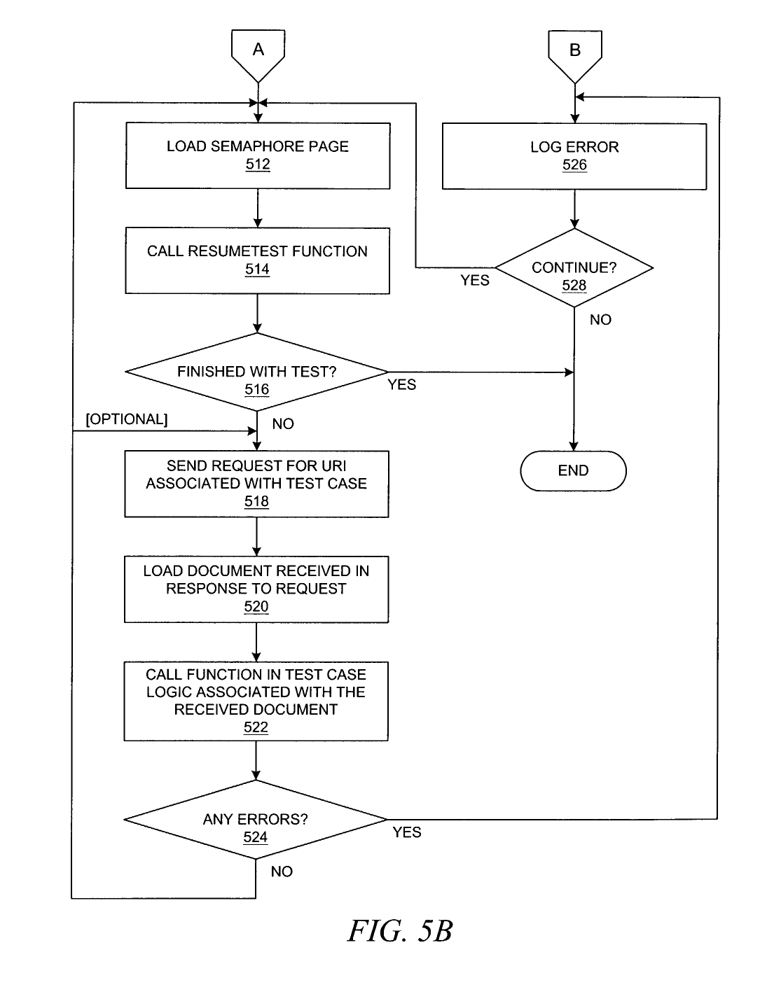

With reference now to FIGS. 5A-5B, a flowchart depicts an overview of the steps that occur during the execution of a test procedure within the test automation facility. The process begins when a user loads the initial file for the test automation facility to create frames within the browser host environment (step 502). The user can select test parameters in the frame that contains the control frame, shown as frame 220 in FIG. 2B (step 504). The user then requests the start of the test (step 506).

A determination is then made as to whether the browser supports features for the test, e.g., by checking the version level of the browser (step 508). If not, then the process branches to log an error. If the browser is acceptable, then a check is made as to whether the selected test parameters are acceptable (step 510). If not, then the process branches to log an error.

If the preliminary error checks are passed, then the semaphore page is loaded into the content frame, shown as frame 250 in FIG. 2B (step 512). The loading of the semaphore page causes the “resumeTest” function to be called (step 514), which checks whether or not the test procedure is complete in accordance with a user-selected duration or looping parameter (step 516). If the test does not need to be repeated, the process is then complete. If the test does need to be repeated (or, if on the first pass, needs to be initiated), then a request is sent to a server for the URI associated with the user-selected test case (step 518). After the browser at the client receives the requested document, it is loaded into the content frame (step 520), which causes its associated function in the test case logic to be called to verify the received content (step 522). A check is made as to whether or not any errors are generated (step 524), and if not, then the process branches back to step 512 to reload the semaphore page. Alternatively, if the test case logic needs to verify another document, the process could branch back to step 518 to load another document to be verified, most likely identified by a different URI. If there are errors, then the process branches to log the error (step 526), and the process is complete. Alternatively, after logging errors, the process could determine to continue with the test procedure, e.g., if the error was not severe (step 528).

The description of the present invention with respect to FIGS. 2A-5B has focused on the client-side processing that occurs within the test automation facility. The description of the remaining figures now turns to a preferred embodiment for server-side processing that supports the operations of the client-side browser environment.

As described above, the content that is received at the browser must contain some type of triggering element that causes the test case logic at the client to be executed against the received content. In the preferred embodiment, assuming that the received document is an HTML-formatted document, the triggering element is an “onLoad” attribute within its “BODY” element; the function name that is referenced by the “onLoad” attribute matches a function name within the test case logic. When triggered, the test case logic operates on the received content.

The simplest way to ensure that the content that is received at the browser contains the necessary triggering element or triggering directive is to place the triggering element statically into a portion of the content that is sent to the client. For example, an HTML document that is identified by a URI can be edited to contain an “onload” attribute similar to line 402 shown in FIG. 4A. When the server retrieves the document in response to a request from the client-side test automation facility, the document already contains the triggering element. Even if some amount of dynamically generated content is added to the static portion of the document, the needed triggering element is contained within the output stream that is sent to the client.

However, this static approach is problematic because it is inflexible. For example, a test engineer may want to apply many different tests against the documents that are received from a Web application, and these test cases may have been previously written such that they were placed in different JavaScript modules. In this particular testing scenario, the test engineer requires the specification of many JavaScript modules. In order to use different “onLoad” attributes that reference the different JavaScript modules, the test engineer would need to edit the static portion of the content, i.e., the document containing the “onLoad” attribute that is stored on the server.

In many cases, the test automation facility would be used to test dynamically generated content from a web application rather than static content. Hence, an alternative approach to ensure that the content that is received at the browser contains the necessary triggering element is to place the triggering element in the dynamically generated content. In other words, the web application would generate the triggering element along with the dynamically generated content. In order to do so, the source code of the web application would have to be modified to include the functionality that could generate the triggering element. This approach is also problematic because the source code of the web application may not be available, e.g., it may be proprietary and subject to restrictions on its distribution. In addition, the personnel who are conducting the tests with the test automation facility may not be the same personnel who wrote the source code, so even if the source code were available, it may be difficult for the testing personnel to instrument the source code in an appropriate manner.

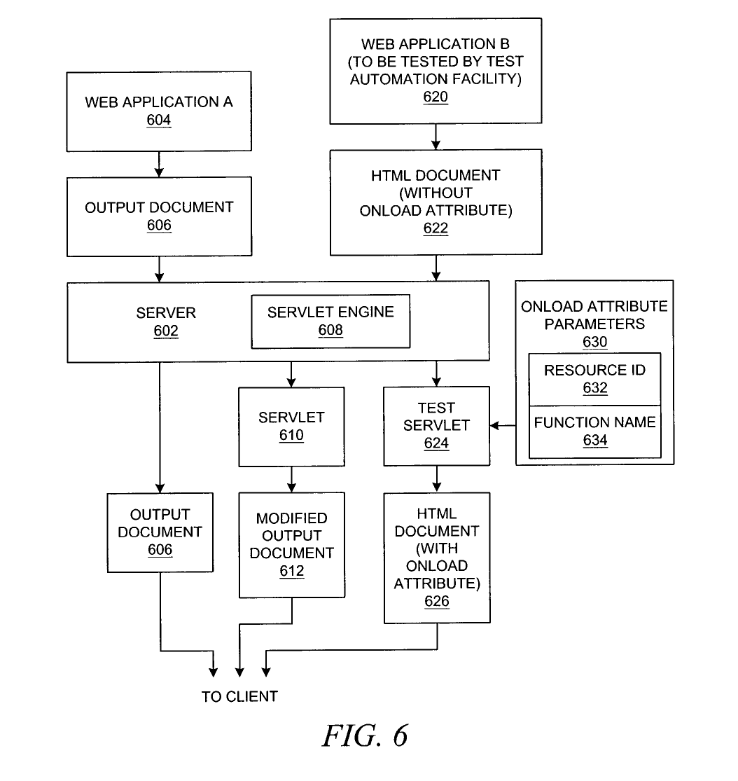

With reference now to FIG. 6, a block diagram depicts a server that supports a filter servlet that dynamically inserts a triggering element into a document that is returned to a test automation facility at a client. In contrast to the two approaches that are mentioned above, a preferred embodiment shown in FIG. 6 dynamically places the triggering element in the output stream using a filter servlet as described in more detail below.

In a well-known manner, server 602 supports the execution of web application 604. Server 602 receives requests for resources, such as Web documents, from clients. Web application 604 generates output document 606 in response to a request from a client, and server 602 returns document 606 in a response message to the client.

Server 602 may also support servlet engine 608 in a well-known manner, such as the Tomcat servlet container, which is an open-source implementation of Java™ Servlet and JavaServer™ Pages technologies developed under the Jakarta project by the Apache Software Foundation. Rather than directly sending the output from a web application to a client, the output can be post-processed by a servlet. The servlet engine can be configured to perform MIME-based (Multipart Internet Mail Extension) filtering in which the servlet engine forwards HTTP responses containing a particular MIME-type to a designated servlet for additional processing. Multiple filters may be chained together. A filter is an extension of the “HttpServlet” class; when a filter intercepts a request, it has access to the “javax.servlet.ServletRequest” and “javax.servlet.Servlet.Response” objects that represent the HTTP request and response. Using these objects, the output from the web application becomes the input to the filter servlet, which can modify the output stream in some manner before the resultant document is sent to the client. In the example shown in FIG. 6, servlet engine 608 can invoke servlet 610 for certain output documents from web application 604, and servlet 610 produces modified output document 612, which is then sent to the client.

The present invention uses web application filters in the following manner. Web application 620 generates document 622 that is to be returned to a client in response to a request by the test automation facility that is executing on the client. Document 622 does not contain a triggering element as required by the test automation facility. Instead, servlet engine 608 invokes test automation facility servlet 624, which filters the output stream to generate modified document 626 that contains the triggering element. Assuming that documents 622 and 626 are HTML documents, servlet 624 inserts an appropriate “onload” attribute into the “BODY” tag of the modified HTML document.

It should be noted that document 622 may already contain a triggering element; assuming that document 622 is an HTML document, then document 622 may have been originally created or edited to include an “onLoad” attribute. Thus, the static portion of the content or the output stream may already contain an “onLoad” attribute when the servlet attempts to insert the “onLoad” attribute. This is not problematic, however, because an “onLoad” attribute may reference multiple JavaScript modules, wherein the names of the modules are separated by semicolons. For example, a “BODY” tag can be present in an HTML document with the following syntax:

[BODY ONLOAD=“APPPROC1( );APPPROC2( );”]

(The square brackets should be replaced by angled brackets, “<” and “>”, in proper HTML syntax and are herein modified to prevent improper interpretation of an electronic HTML version of this document.) This feature of the “onLoad” attribute allows the servlet to insert the name of the test module into an “onLoad” attribute that is already present in the document. Preferably, the servlet appends the name of the test module to any other modules that are already referenced by the “onLoad” attribute. Using the example above, servlet 624 would modify the “onLoad” attribute to appear as follows when inserting a reference to a testing module:

[BODY ONLOAD=“APPPROC1( );APPPROC2( );TESTPROC1( )”]

In this manner, the test automation facility servlet may insert an “onLoad” attribute into the output stream or may insert a test script module name into a pre-existing “onLoad” attribute within the output stream, as appropriate.

A test engineer may use the test automation facility to test the content of many different documents, each of which originate from the same Web application but in which all of the documents contain different content. In addition, the test engineer may use the test automation facility to test documents that originate from many different Web applications. Given multiple different scenarios for using the test automation facility, the test automation facility servlet would be too restrictive if it were hard-coded to insert only one form of triggering element into the output documents. In order to configure the test automation facility servlet to be able to filter multiple different types of documents, the test servlet can retrieve parameters to be used when generating the triggering elements that are inserted into the outgoing documents.

In the example shown in FIG. 6, test servlet 624 reads parameter file 630 which contains multiple name-value pairs, each of which contains a resource identifier and a function name. A single name-value pair is shown as resource ID 632 and its associated function name 634. Each name in the name-value pairs corresponds to an identifier of a resource that may be requested during a test. When servlet 624 receives a document to be filtered, servlet 624 obtains the name or identifier for the originally requested resource and attempts to match the identifier with one of the name-value pairs; if a matching resource identifier is found, then servlet 624 uses the function name that is associated with the resource identifier in the name-value pair as the test case function that is referenced by the triggering element. In this manner, the test servlet inserts an appropriate triggering element for the type of document that is being returned; in other words, the triggering element that is inserted into the document will cause the appropriate test case function to be invoked against the document. An example of this is explained in more detail further below.

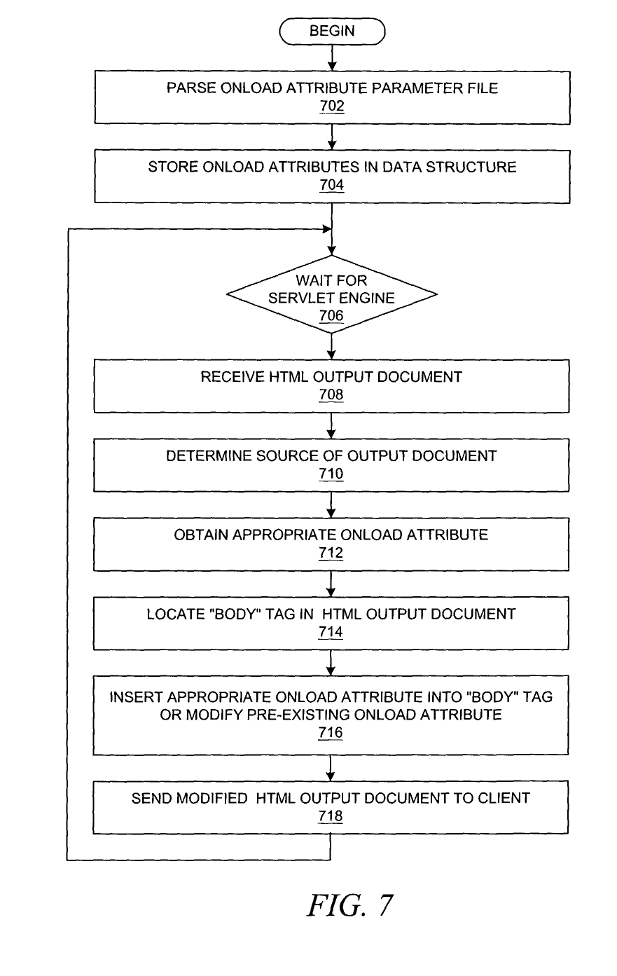

With reference now to FIG. 7, a flowchart depicts a process within a test automation facility servlet that filters output documents to insert appropriate triggering elements into the output documents, wherein the triggering elements are used by a test automation facility at the client to test the documents after they are received at the client. The process begins when the test automation facility servlet is initialized, during which it retrieves and parses an “onLoad” element parameter file (more generally, a triggering element parameter file) (step 702), similar to file 630 that is shown in FIG. 6, and the servlet stores the parameters into an appropriate data structure (step 704). Other appropriate initialization procedures may also be completed in accordance with the type of servlet engine or other server environment requirements.

As noted above, a filter is an extension of the “HttpServlet” class, and the servlet implements the “inito” method and the “service( )” method of this class. During the initialization phase for the servlet, the “inito” method is invoked after the servlet is instantiated, and the “init( )” method reads the triggering element parameter file and loads the information into an appropriate data structure.

The triggering element parameter file contains information for allowing the test automation facility servlet to tailor the triggering element for the particular output document into which the triggering element is being placed. The information that is contained within the triggering element parameter file depends on the type of triggering element that is used by the test automation facility.

If the output documents are HTML documents, then the triggering element is an “onLoad” attribute that is to be placed within the “BODY” tag of an output HTML document. In this particular example of an implementation of the present invention, the triggering element parameter file contains the function names that are put into the “onLoad” attribute; in other words, the function names refer to the test case logic functions that are eventually called in the test automation facility at the client. The function names have been previously associated as a name-value pair with a resource name or identifier; the resource name identifies a resource that may be requested by the client and that causes a Web application on the server to generate an output document in response to processing the request. Referring back to steps 702 and 704, in this example of the present invention, the name-value pairs of function names and resource names are loaded into a data structure during the initialization phase of the servlet. In a preferred embodiment, the triggering element parameter file is an XML-formatted file, and the test automation facility servlet builds a W3C (World Wide Web Consortium) Document Object Model (DOM) structure to contain the “onLoad” attribute parameters using the Java API (Application Programming Interface) for XML Parsing (JAXP) API.

After the initialization phase, the test automation facility servlet waits to be invoked by the servlet engine (step 706). In a preferred embodiment, the servlet engine forwards all HTTP responses that have a MIME-type of “text/html” (the default type in any HTML header) to the test automation facility servlet. In this manner, the servlet receives an HTML output document (step 708).

The servlet then determines the resource name associated with the output document in an appropriate manner (step 710). In a preferred embodiment, the “service( )” method (mentioned above) would be invoked, which can determine the URI that was originally requested by an incoming HTTP request message. Alternatively, the “service()” method obtains Web application context information in order to determine a resource name.

After the resource name is determined, the servlet obtains an appropriate triggering element parameter (step 712), e.g., a function name for an “onLoad” attribute, from the previously generated data structure. In a preferred embodiment, the servlet searches the element nodes in the DOM data structure for a matching resource name. The servlet then locates the appropriate place to insert the triggering element and its parameters into the output document (step 714) and then inserts the triggering element and its parameters (step 716), e.g., an “ONLOAD=function_name( )” attribute would be inserted into the “BODY” tag in the output document or a pre-existing “onLoad” attribute would be modified to include a reference to the function name. The modified output document is then sent to the client (step 718), and the process is complete. When the modified output document is received at the client that is supporting the test automation facility in its browser application environment, the triggering element will be used in the manner previously described above.

The advantages of the present invention should be apparent in view of the detailed description of the invention that is provided above. The most important advantage of the present invention is that the present invention is standards-based and does not require proprietary applications and programming languages to perform the desired tests. Due to the nature of the test automation facility of the present invention, the present invention relies on the built-in capabilities of widely available browsers.

Prior art testing solutions are written in operating system or platform-dependent programming languages that limit their portability. In contrast, the present invention may be deployed on a system in a platform-independent manner in conjunction with any compatible browser that has the required functionality for interpreting markup language tags and standard scripting languages. Since most browsers, including Netscape® Navigator and Microsoft® Internet Explorer, have such capabilities and have been ported to many different platforms, the present invention can be used in any environment with a supported browser.

Some of the prior art solutions emulate the operations of browsers through virtual users by driving the graphical user interface of a browser as if a user might be commanding a browser to perform certain actions. Emulation, though, is not the same as actual use, so other factors or variables must be considered when certain problems occur during a failed test with these prior art solutions. For example, these solutions introduce other variables because of the testing application's use of system resources, such as memory, disk space, processor time, and network bandwidth requirements. If a memory leak or trap is detected, then the testing application must be eliminated as the source of the problem. As another example, an emulated virtual user of a browser can be driven to perform certain actions more quickly than an actual user might control a browser, thereby masking certain problems that might have been noticed had the browser been operated in a more natural fashion; in addition, timing problems or race conditions might be created using emulation that might not be possible with actual users. In particular, a testing solution might start processing certain documents, such as forms, before they are entirely loaded into the browser or before certain associated text and images would be visible in an active browser window or frame.

In contrast, the present invention relies on the actual operation of the browser so that no other programs, such as one or more testing applications, are using system resources. If a supported browser is available for a client machine's operating system, then no further products need to be installed or running during the test when the automated test facility of the present invention is being used. All of the testing logic's use of resources occurs within the browser's own process and address space. Hence, system resource requirements during the testing processes are the same as would be observed by an actual user operating the browser, thereby providing an advantage that performance metrics can be observed in real-time. In addition, since the test facility of the present invention uses the browser itself for processing markup language elements in the received files, the present invention relies on the browser for controlling the timing and the interpretation of the markup language. The browser must fully load a markup language document before processing of test logic can begin, thereby ensuring the browser is tested in a manner that closely mirrors the way that an actual user would control the browser.

The server-side processing that supports the operations of the test automation facility in the client-side browser environment can be implemented so as to minimize the amount of configuration operations that must be performed by a test engineer or analyst. Any triggering element parameters that are customizable can be dynamically inserted into the output documents from the server through the use of a filter servlet on the server.

It is important to note that while the present invention has been described in the context of a fully functioning data processing system, those of ordinary skill in the art will appreciate that the processes of the present invention are capable of being distributed in the form of instructions or other means on a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for processing documents in a data processing system, the method comprising:
obtaining a first markup language document by a server-side process;
in response to obtaining the first markup language document, inserting or modifying by the server-side process a triggering element in the first markup language document to generate a modified markup language document, wherein the triggering element is interpreted by a client browser when loading a document containing the triggering element to call a function in scripting language statements in a second markup language document; and
sending the modified markup language document to the client.

2. The method of claim 1 wherein the markup language is Hypertext Markup Language (HTML).

3. The method of claim 2 wherein the triggering element is an HTML “onLoad” attribute.

4. The method of claim 1 wherein the server-side process executes within a filter servlet.

5. The method of claim 1 wherein the function verifies contents of the modified markup language document at the client.

6. The method of claim 1 further comprising:
retrieving a resource name that is associated with the first markup language document;
retrieving a function name for the function that is associated with the resource name; and
setting the function name in the triggering element.

7. The method of claim 6 wherein the resource name is a Uniform Resource Identifier (URI).

8. The method of claim 1 wherein the scripting language statements are JavaScript statements.

9. An apparatus for processing documents, the apparatus comprising:
means for obtaining a first markup language document by a server-side process;
means for inserting or modifying by the server-side process a triggering element in the first markup language document to generate a modified markup language document in response to obtaining the first markup language document, wherein the triggering element is interpreted by a client browser when loading a document containing the triggering element to call a function in scripting language statements in a second markup language document; and
means for sending the modified markup language document to the client.

10. The apparatus of claim 9 wherein the markup language is Hypertext Markup Language (HTML).

11. The apparatus of claim 10 wherein the triggering element is an HTML “onLoad” attribute.

12. The apparatus of claim 9 wherein the server-side process executes within a filter servlet.

13. The apparatus of claim 9 wherein the function verifies contents of the modified markup language document at the client.

14. The apparatus of claim 9 further comprising:
means for retrieving a resource name that is associated with the first markup language document;
means for retrieving a function name for the function that is associated with the resource name; and
means for setting the function name in the triggering element.

15. The apparatus of claim 14 wherein the resource name is a Uniform Resource Identifier (URI).

16. The apparatus of claim 9 wherein the scripting language statements are JavaScript statements.

17. A computer program product on a computer readable medium for use in a data processing system for processing documents, the computer program product comprising:
means for obtaining a first markup language document by a server-side process;
means for inserting or modifying by the server-side process a triggering element in the first markup language document to generate a modified markup language document in response to obtaining the first markup language document, wherein the triggering element is interpreted by the client browser when loading a document containing the triggering element to call a function in scripting language statements in a second markup language document; and
means for sending the modified markup language document to the client.

18. The computer program product of claim 17 wherein the markup language is Hypertext Markup Language (HTML).

19. The computer program product of claim 18 wherein the triggering element is an HTML “onLoad” attribute.

20. The computer program product of claim 17 wherein the server-side process executes within a filter servlet.

21. The computer program product of claim 17 wherein the function verifies contents of the modified markup language document at the client.

22. The computer program product of claim 17 further comprising:
means for retrieving a resource name that is associated with the first markup language document;
means for retrieving a function name for the function that is associated with the resource name; and
means for setting the function name in the triggering element.

23. The computer program product of claim 22 wherein the resource name is a Uniform Resource Identifier (URI).

24. The computer program product of claim 17 wherein the scripting language statements are JavaScript statements.
